(19) United States
(12) Patent Application Publication
(10) Pub. No.: US 2023/0058184 A1
(43) Pub. Date: Feb. 23, 2023

(54) IMAGE DEVICE

(71) Applicant: SK hynix Inc., Icheon-si (KR)

(72) Inventor: Daisuke SHIRAISHI, Tokyo (JP)

(21) Appl. No.: 17/877,782

(22) Filed: Jul. 29, 2022

(30) Foreign Application Priority Data
Aug. 19, 2021 (KR) 10-2021-0109534

(51) Int. Cl. G06T 5/00; G06V 10/141; G06V 10/60; G06V 10/74

(52) U.S. Cl. CPC G06T 5/006; G06V 10/141; G06V 10/60; G06V 10/761

(57) ABSTRACT

An imaging device includes an image sensing unit configured to generate image data by sensing incident light received from a scene, a line buffer configured to store image data received from the image sensing unit, an optical distortion corrector (ODC) configured to perform lens distortion correction for output pixel coordinates based on input pixel coordinates of the image data stored in the line buffer, and a read speed controller configured to control a read speed at which the image data is read from the line buffer according to the output pixel coordinates.

### CROSS-REFERENCE TO RELATED APPLICATION

This patent document claims the priority and benefits of Korean patent application No. 10-2021-0109534, filed on Aug. 19, 2021, the disclosure of which is incorporated herein by reference in its entirety as part of the disclosure of this patent document.

### TECHNICAL FIELD

The technology and implementations disclosed in this patent document generally relate to an imaging device capable of generating image data by sensing light.

### BACKGROUND

An image sensing device is a device for capturing optical images by converting light into electrical signals using a photosensitive semiconductor material which reacts to light. With the development of automotive, medical, computer and communication industries, the demand for high-performance image sensing devices is increasing in various fields such as smart phones, digital cameras, game machines, IoT (Internet of Things), robots, security cameras and medical micro cameras.

The image sensing device may be roughly divided into CCD (Charge Coupled Device) image sensing devices and CMOS (Complementary Metal Oxide Semiconductor) image sensing devices. The CCD image sensing devices offer a better image quality, but they tend to consume more power and are larger as compared to the CMOS image sensing devices. The CMOS image sensing devices are smaller in size and consume less power than the CCD image sensing devices. Furthermore, CMOS sensors are fabricated using the CMOS fabrication technology, and thus photosensitive elements and other signal processing circuitry can be integrated into a single chip, enabling the production of miniaturized image sensing devices at a lower cost. For these reasons, CMOS image sensing devices are being developed for many applications including mobile devices.

### SUMMARY

Various embodiments of the disclosed technology relate to an imaging device capable of correcting lens distortion.

In one aspect, an imaging device may include an image sensing unit configured to generate image data by sensing incident light received from a scene, a line buffer configured to store image data received from the image sensing unit, an optical distortion corrector (ODC) configured to perform lens distortion correction for output pixel coordinates based on input pixel coordinates of the image data stored in the line buffer, and a read speed controller configured to control a read speed at which the image data is read from the line buffer according to the output pixel coordinates.

In another aspect, an image device is provide to include an image sensing unit structured to include image sensing pixels operable to sense incident light received from a scene and to generate pixel signals carrying image information of the scene; a lens module positioned to project the incident light from the scene onto the image sensing pixels of the image sensing unit; a line buffer coupled to be in communication with the image sensing unit and configured to store image data generated from the pixel signals from the image sensing unit; an optical distortion corrector (ODC) configured to perform lens distortion correction to output pixel coordinates based on input pixel coordinates of the image data stored in the line buffer to correct a distortion caused by the lens module; and a line buffer controller coupled to the line buffer and configured to control a read speed at which the image data is read from the line buffer to the optical distortion corrector according to the output pixel coordinates.

In another aspect, an imaging device is provided to include a line buffer configured to store image data generated by sensing incident light, an optical distortion corrector (ODC) configured to receive the image data from the line buffer and perform lens distortion correction for output pixel coordinates, and a line buffer controller configured to control a read speed at which the image data is read from the line buffer, based on a reference line corresponding to an output line including the output pixel coordinates.

It is to be understood that both the foregoing general description and the following detailed description of the disclosed technology are illustrative and explanatory and are intended to provide further explanation of the disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an imaging system based on some implementations of the disclosed technology.

FIG. 2 is a block diagram illustrating an example of an image sensing unit shown in FIG. 1.

FIG. 3 is a conceptual diagram illustrating an example of lens distortion correction.

FIG. 4 is a diagram illustrating that the range of lines to be referenced varies depending on the position of each pixel during lens distortion correction.

FIG. 5 is a graph illustrating the relationship between output pixel coordinates and input pixel coordinates required for lens distortion correction of pixels corresponding to the output pixel coordinates according to one example of lens distortion.

FIG. 6 is a graph illustrating the capacity of a line buffer required when image data is read at a relatively low read speed in the graph of FIG. 5.

FIG. 7 is a graph illustrating the capacity of a line buffer required when image data is read at a relatively high read speed in the graph of FIG. 5.

FIGS. 8(a) and 8(b) show diagrams illustrating one example of a method for adjusting a read speed of the line buffer.

FIGS. 9(a) and 9(b) show diagrams illustrating another example of a method for adjusting the read speed of the line buffer.

FIG. 10 is a graph illustrating the relationship between output pixel coordinates and input pixel coordinates required for lens distortion correction of pixels corresponding to the output pixel coordinates according to another example of lens distortion.

FIG. 11 is a graph illustrating the relationship between the line buffer having the same capacity and the same read speed as those of FIG. 7 and lens distortion of FIG. 10.

FIG. 12 is a graph illustrating the capacity of a line buffer required when image data is read at a constant read speed in the graph of FIG. 10.

FIG. 13 is a graph illustrating the capacity of a line buffer required when image data is read at a variable read speed in the graph of FIG. 10.

FIG. 14 is a diagram illustrating the capacity of a line buffer required when distorted image data shown in FIG. 3 is read at a constant read speed and lens distortion correction for the distorted image data is performed.

FIG. 15 is a diagram illustrating the capacity of a line buffer required when distorted image data shown in FIG. 3 is read at a variable read speed and lens distortion correction for the distorted image data is performed.

### DETAILED DESCRIPTION

This patent document provides implementations and examples of an imaging device capable of generating image data by sensing light that may be used in configurations to substantially address one or more technical or engineering issues and to mitigate limitations or disadvantages encountered in some other imaging devices. Some implementations of the disclosed technology relate to the imaging device capable of correcting lens distortion. The disclosed technology provides various implementations of an imaging device that can minimize the capacity required for the line buffer by varying the read speed of the line buffer.

Reference will now be made in detail to the embodiments of the disclosed technology, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

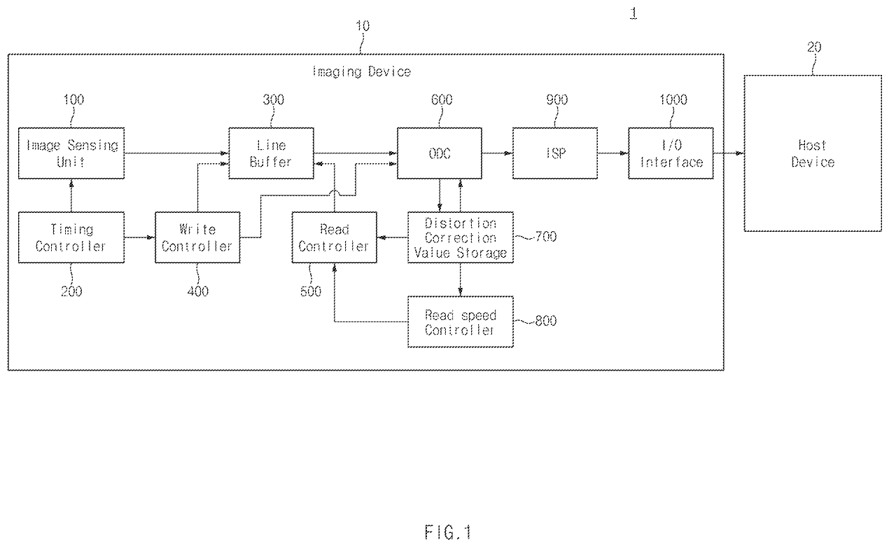

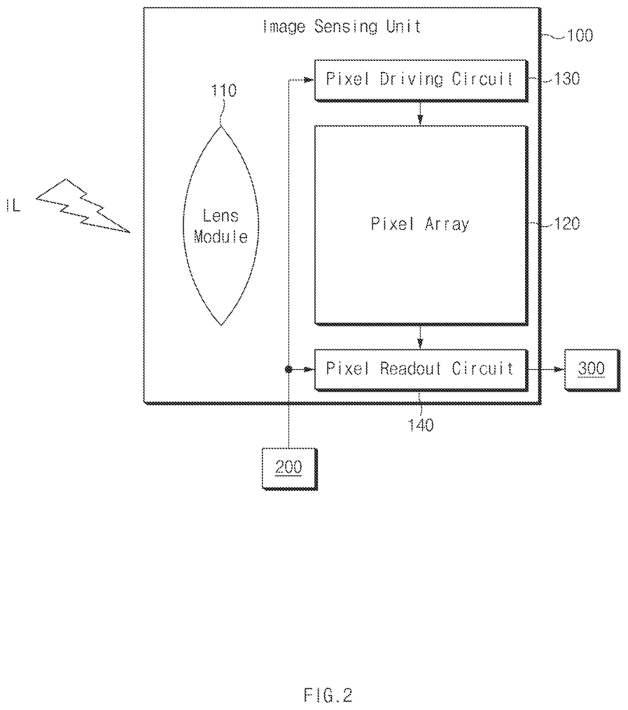

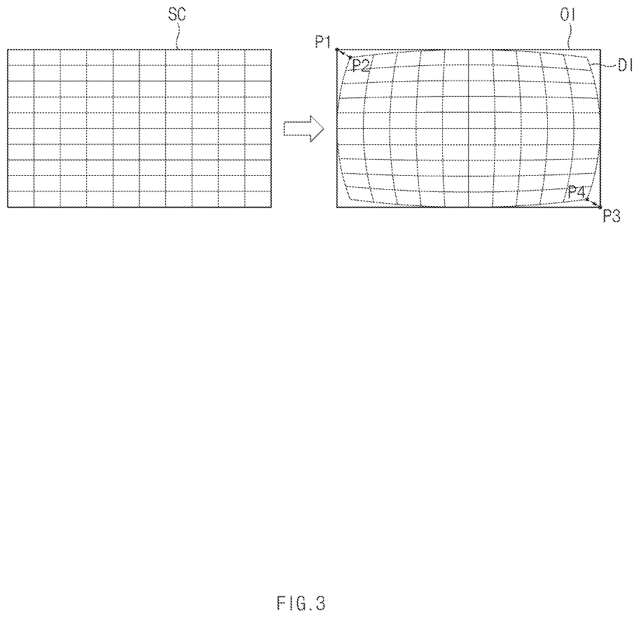

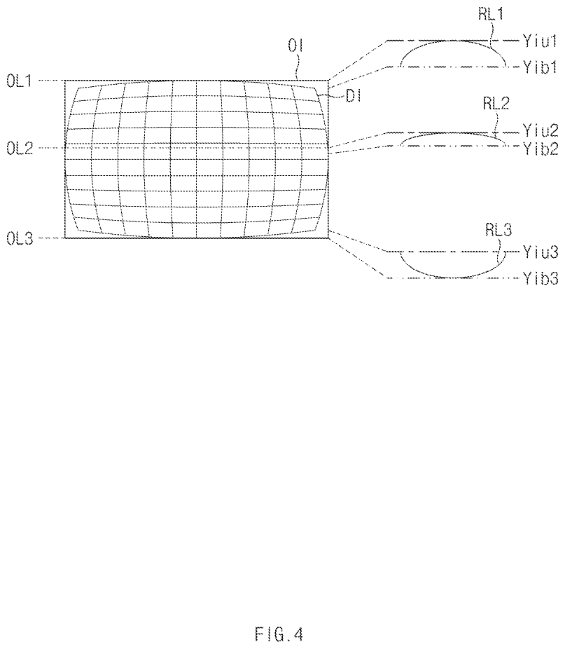

FIG. 1 is a block diagram illustrating an example of an imaging system based on some implementations of the disclosed technology. FIG. 2 is a block diagram illustrating an example of an image sensing unit shown in FIG. 1. FIG. 3 is a conceptual diagram illustrating an example of lens distortion correction. FIG. 4 is a diagram illustrating that the range of lines to be referenced varies depending on the position of each pixel during lens distortion correction.

Referring to FIG. 1, the imaging system 1 may refer to a device, for example, a digital still camera for photographing still images or a digital video camera for photographing moving images. For example, the imaging device 10 may be implemented as a Digital Single Lens Reflex (DSLR) camera, a mirrorless camera, or a smartphone, and others. The imaging device 10 may include a device having both a lens and an image pickup element such that the device can capture (or photograph) a target object and can thus create an image of the target object.

The imaging system 1 may include an imaging device 10 and a host device 20.

The imaging device 10 may include an image sensing unit 100, a timing controller 200, a line buffer 300, a write controller 400, a line buffer read controller that includes a read controller 500 and a read speed controller 800, an optical distortion corrector (ODC) 600, a distortion correction value storage 700, an image signal processor (ISP) 900, and an input/output (I/O) interface 1000. The read controller 500 and the read speed controller 800 can be collectively referred to as a line buffer controller.

The image sensing unit 100 may be a complementary metal oxide semiconductor image sensor (CIS) for converting an optical signal into an electrical signal. The image sensing unit 100 may control overall operations such as on/off, operation mode, operation timing, sensitivity, etc. by the timing controller 200. The image sensing unit 100 may provide the line buffer 300 with image data obtained by converting the optical signal into the electrical signal based on the control of the timing controller 200.

Referring to FIG. 2, the image sensing unit 100 may include a lens module 110, a pixel array 120, a pixel driving circuit 130, and a pixel readout circuit 140.

The lens module 110 may collect incident light received from a scene image, and may allow the collected light to be focused onto pixels of the pixel array 120. The lens module 110 may include a plurality of lenses aligned with an optical axis. The lens module 110 may have a predetermined curvature so that the pixel array 120 can sense a scene corresponding to a predetermined field of view (FOV). However, due to this curvature, there may occur lens distortion caused by a difference in the scene and the frame sensed by the pixel array 120.

The pixel array 120 may include a plurality of unit pixels arranged in N rows (where N is an integer of 2 or more) and M columns (where M is an integer of 2 or more). In one example, the plurality of unit pixels may be arranged in a two-dimensional (2D) pixel array including rows and columns. In another example, the plurality of unit pixels may be arranged in a three-dimensional pixel array.

The plurality of unit pixels may convert an optical signal into an electrical signal on a unit pixel basis or a pixel group basis, where unit pixels in a pixel group share at least certain internal circuitry.

Each of the plurality of unit pixels may sense incident light (IL) to generate a pixel signal corresponding to the intensity of incident light (IL). The pixel array 120 may receive driving signals, including a row selection signal, a pixel reset signal and a transmission signal, from the pixel driving circuit 130. Upon receiving the driving signal, the corresponding unit pixels of the pixel array 120 may be activated to perform the operations corresponding to the row selection signal, the pixel reset signal, and the transmission signal.

The pixel driving circuit 130 may activate the pixel array 120 to perform certain operations on the imaging pixels in the corresponding row based on commands and control signals provided by controller circuitry such as the timing controller 200. In some implementations, the pixel driving circuit 130 may select one or more imaging pixels arranged in one or more rows of the pixel array 120. The pixel driving circuit 130 may generate a row selection signal to select one or more rows among the plurality of rows in response to a row address signal of the timing controller 200. The pixel driving circuit 130 may sequentially enable the pixel reset signal for resetting imaging pixels corresponding to at least one selected row, and the transmission signal for the pixels corresponding to the at least one selected row. Thus, a reference signal and an image signal, which are analog signals generated by each of the imaging pixels of the selected row, may be sequentially transferred to the pixel readout circuit 140. The reference signal may be an electrical signal that is provided to the pixel readout circuit 140 when a sensing node of an imaging pixel (e.g., floating diffusion node) is reset, and the image signal may be an electrical signal that is provided to the pixel readout circuit 140 when photocharges generated by the imaging pixel are accumulated in the sensing node. The reference signal indicating unique reset noise of each pixel and the image signal indicating the intensity of incident light may be generically referred to as a pixel signal as needed.

The pixel readout circuit 140 may use correlated double sampling (CDS) to remove undesired offset values of pixels known as the fixed pattern noise by sampling a pixel signal twice to remove the difference between these two samples (i.e., a reference signal and an image signal). In one example, correlated double sampling (CDS) may remove the undesired offset value of pixels by comparing pixel output voltages obtained before and after photocharges generated by incident light are accumulated in the sensing node so that only pixel output voltages based on the incident light can be measured. In some embodiments of the disclosed technology, the pixel readout circuit 140 may sequentially sample and hold voltage levels of the reference signal and the image signal, which are provided to each of a plurality of column lines from the pixel array 120. That is, the pixel readout circuit 140 may sample and hold the voltage levels of the reference signal and the image signal which correspond to each of the columns of the pixel array 120.

The pixel readout circuit 140 may include an analog-to-digital converter (ADC) for converting a correlated double sampling signal into a digital signal. In some implementations, the ADC may be implemented as a ramp-compare type ADC. The ramp-compare type ADC may include a comparator circuit for comparing the analog pixel signal with a reference signal such as a ramp signal that ramps up or down, and a timer for performing counting until a voltage of the ramp signal matches the analog pixel signal.

The pixel readout circuit 140 may include an output buffer that temporarily holds the column-based image data provided from the ADC to output the image data. In one example, the output buffer may temporarily store image data output from the ADC based on control signals of the timing controller 200. The output buffer may provide an interface to compensate for data rate differences or transmission rate differences between the image sensing unit 100 and other devices.

The pixel readout circuit 140 may include a column driver. The column driver may select a column of the output buffer upon receiving a control signal from the timing controller 200, and sequentially output the image data, which are temporarily stored in the selected column of the output buffer. In some implementations, upon receiving a column address signal from the timing controller 200, the column driver may select a column of the output buffer based on the column address signal so that image data from the selected column of the output buffer can be output to the line buffer 300.

Referring back to FIG. 1, the timing controller 200 may provide the image sensing unit 100 with a clock signal required for the operations of the respective components of the image sensing unit 100, a control signal for timing control, a row address signal for selecting a row, and a column address signal for selecting a column. In an embodiment of the disclosed technology, the timing controller 200 may include a logic control circuit, a phase locked loop (PLL) circuit, a timing control circuit, a communication interface circuit and others.

The timing controller 200 may provide the write controller 400 with the row address signal and the column address signal transferred to the image sensing unit 100.

The line buffer 300 may write (i.e., store) image data received from the image sensing unit 100 based on the control of the write controller 400, may read the image data based on the control of the read controller 500, and may transmit the read image data to the ODC 600. The write operation and the read operation of the line buffer 300 will be described later with reference to the write controller 400 and the read controller 500.

The line buffer 300 may include a volatile memory (e.g., DRAM, SRAM, etc.) and/or a non-volatile memory (e.g., a flash memory). The line buffer 300 may have a capacity capable of storing image data corresponding to a predetermined number of lines. Each of the lines may refer to a row of the pixel array 120, and the predetermined number of lines may be less than the total number of rows of the pixel array 120. Accordingly, the line buffer 300 is not a frame memory capable of storing image data corresponding to a frame captured by the pixel array 120 at once, but a line memory capable of storing image data corresponding to some rows (or lines) of the pixel array 120. The capacity of the line buffer 300 may be determined by the degree of lens distortion of the lens module 110, the generation and processing speed of image data, or others. The capacity of the line buffer 300 discussed in the patent document may refer to a capacity that can be allocated to store image data.

The write controller 400 may generate input pixel coordinates based on the row address signal and the column address signal that are received from the timing controller 200, and may transmit the input pixel coordinates to each of the line buffer 300 and the ODC 600. The input pixel coordinates may refer to coordinates of pixels corresponding to image data that is input from the image sensing unit 100 to the line buffer 300.

The coordinates of each pixel included in the pixel array 120 may be determined by a row and a column to which a corresponding pixel belongs. For example, the coordinates of the pixel belonging to a fifth row and a tenth column may be (10, 5). When the image data corresponding to the pixel corresponding to the coordinates (10, 5) is input to the line buffer 300, the write controller 400 may receive a row address signal indicating a fifth row and a column address signal indicating a tenth column from the timing controller 200, and may generate input pixel coordinates corresponding to the coordinates (10, 5) based on the row address signal and the column address signal.

Thus, the row address signal may represent the Y-coordinate of a pixel corresponding to image data input to the line buffer 300, and the column address signal may represent the X-coordinate of a pixel corresponding to image data input to the line buffer 300.

The line buffer 300 may map the image data received from the image sensing unit 100 to the input pixel coordinates received from the write controller 400, and may store the mapped image data. Here, the mapping and storing operation by the line buffer 300 may indicate that the image data and the input pixel coordinates are stored in correspondence with each other, so that the line buffer 300 can identify image data corresponding to specific input pixel coordinates.

The ODC 600 may determine whether to start lens distortion correction based on the input pixel coordinates received from the write controller 400. More detailed description thereof will be given later in this patent document.

The read controller 500 may receive reference pixel coordinates from the distortion correction value storage 700, and may control the line buffer 300 to output image data corresponding to the reference pixel coordinates to the ODC 600. In some implementations, the read controller 500 transmits the reference pixel coordinates to the line buffer 300, and the line buffer 300 reads the image data corresponding to the reference pixel coordinates and outputs the read image data to the ODC 600. The line buffer 300 store the image data as being mapped to the input pixel coordinates and thus can read image data corresponding to the input pixel coordinates same as the reference pixel coordinates. Here, the reference pixel coordinates may refer to coordinates of pixels needed for lens distortion correction of the ODC 600.

In addition, the read controller 500 may transmit the reference pixel coordinates to the line buffer 300 in response to a timing point determined by a line spacing (line spacing) control value of the read speed controller 800. Here, the line spacing may refer to a time gap between a time point where image data corresponding to any one row of the pixel array 120 is completely read and the other time point where reading of the image data corresponding to the next row is started. That is, the line spacing may refer to a time section between read times of adjacent rows of the pixel array 120.

The line spacing control value may be information for determining the line spacing. As the line spacing control value increases, the line spacing may increase. As the line spacing control value decreases, the line spacing may decrease. If it is assumed that a time section from one time point where reading of image data corresponding to any one row of the pixel array 120 is started to the other time point where reading of image data corresponding to the next row is started is defined as an output time, the read speed (i.e., the amount of image data that is read from the line buffer 300 per unit time) of the line buffer 300 may be inversely proportional to the output time. That is, as the output time is shortened due to a smaller line spacing, the read speed of the line buffer 300 may increase.

The read controller 500 may transmit the reference pixel coordinates to the line buffer 300 at a time determined by a line spacing control value, so that the line buffer 300 can read image data at intervals of a predetermined line spacing corresponding to the line spacing control value of the read speed controller 800. For example, after reading of the image data corresponding to a current row is ended, the read controller 500 may transmit the reference pixel coordinates to the line buffer 300 at the corresponding timing point, so that reading of image data corresponding to the next row to be read can be started after lapse of 100 cycles from the end point of the reading of the image data corresponding to the current row. In this case, the cycle may refer to a clock cycle for use in the imaging device 10. In addition, the cycle may refer to a time taken to generate and write image data corresponding to one pixel, or may refer to a time taken to read image data corresponding to one pixel and to perform lens distortion correction for the read image data.

The ODC 600 may perform lens distortion correction for the image data, so that the ODC 600 may transmit the corrected image data to the ISP 900.

Referring to FIG. 3, a scene (SC) to be photographed and original image data (OI) corresponding to a frame photographed by the image sensing unit 100 are shown together. The lens module 110 may have a predetermined curvature to transmit light of a scene corresponding to a predetermined FOV to the pixel array 120, so that lens distortion caused by a difference between the scene (SC) and the original image data (OI) may occur due to such curvature of the lens module 110.

An image corresponding to a specific position included in the scene (SC) may not be sensed at a pixel disposed at the same position as the specific position, but may be detected at another pixel disposed at a different position from the specific position.

For example, an image corresponding to a left-end and upper-end vertex position within the scene (SC) may not be sensed at a first pixel (P1) corresponding to the same left-end and upper-end vertex position within the original image data (OI), but may be sensed at a second pixel (P2) disposed at a different position from the left-end and upper-end vertex position within the original image data (OI).

Alternatively, an image corresponding to a right-end and lower-end vertex position within the scene (SC) may not be sensed at a third pixel (P3) corresponding to the same right-end and lower-end vertex position within the original image data (OI), but may be sensed at a fourth pixel (P4) disposed at a different position from the right-end and lower-end vertex position.

As shown in FIG. 3, the scene (SC) is divided into a plurality of square regions and the light from those different regions of the scene is received by the lens module 110 in FIG. 2 and is projected by the lens module 110 onto the image sensing pixels in the pixel array 120. When the lens module 110 is free of the lens distortion, the light pattern carried by the light from the different regions of the scene is projected by lens module 110 as a projected light pattern onto the pixel array 120 that has the same relative positions of the regions in the scene and maintains the same portions of the regions in the scene at the pixel array 120. This projected light pattern without distortions is captured by image sensing pixels of the pixel array 120 to generate image data representing the plurality of square regions as the original image data (OI). In an actual device, however, different light rays from the different regions of the scene transmit through the lens module 110 along different paths through the lens module 110 so that, lens distortion may occur in the light received by the pixel array 120 due to the curvature and thickness profile of one or more lenses in the lens module 110. As a result, due to such lens distortion, the geometry of the light pattern projected by the lens module 110 onto the pixel array 120 is distorted so that the plurality of square regions included in the scene (SC) may not correspond to the original image data (OI), but may correspond to distorted image data (DI) including a plurality of distorted square regions, each of which is formed in a distorted shape. Due to the lens distortion, the square regions of the distorted image data (DI) may not perfectly correspond to the square regions of the scene (SC), respectively. For example, assuming the lens module 110 has a lens distortion profile that is radially symmetric with respect to the center of the lens module 110, the closer the square regions of the distorted image data (DI) are to the center of the lens module 110, the lesser the degree of distortion of the square regions of the distorted image data (DI). As the square regions of the distorted image data (DI) are located closer to the center of the distorted image data (DI), the degree of lens distortion becomes weaker, and as the square regions of the distorted image data (DI) are located farther from the center of the distorted image data (DI), the degree of lens distortion becomes stronger.

The position and shape of distorted image data (DI) may vary depending on the curvature, etc. of each lens in the lens module 110. The barrel like distortion pattern illustrated in FIG. 3 is an example only.

Lens distortion correction may refer to an image process for correcting distortion caused by the lens module 110. Lens distortion correction for a specific pixel may refer to an operation for reading image data of a pixel corresponding to the reference pixel coordinates matched to coordinates of the specific pixel, and processing the read image data. In some implementations, the processing operation of the read image data may refer to an operation for calculating/processing a predetermined correction parameter on the read image data.

For example, lens distortion correction for the first pixel (P1) may include reading image data of the second pixel (P2) corresponding to the reference pixel coordinates matched to the coordinates of the first pixel (P1), and calculating/processing a predetermined correction parameter using the read image data.

Referring to FIG. 4, a first output line (OL1), a second output line (OL2), and a third output line (OL3) are illustrated. The first output line (OL1) may refer to a set of pixels corresponding to the first row of the pixel array 120, the second output line (OL2) may refer to a set of pixels corresponding to a row (e.g., a 500^{-th} row among a total of 1080 rows) disposed closer to the center of the pixel array 120, and the third output line (OL3) may refer to a set of pixels corresponding to the last row of the pixel array 120.

The set of pixels required for lens distortion correction for the first output line (OL1) may be denoted by a first reference line (RL1) that is a portion of the distorted image data (DI). The first reference line (RL1) may refer to a set of pixels corresponding to the reference pixel coordinates matched to coordinates of each of the pixels belonging to the first output line (OL1). The pixels included in the first reference line (RL1) may have Y-coordinates that are less than or equal to first upper-end coordinates (Yiu1) and greater than or equal to first lower-end coordinates (Yib1).

The set of pixels required for lens distortion correction for the second output line (OL2) may be denoted by a second reference line (RL2) that is a portion of the distorted image data (DI). The second reference line (RL2) may refer to a set of pixels corresponding to the reference pixel coordinates matched to coordinates of each of the pixels belonging to the second output line (OL2). The pixels included in the second reference line (RL2) may have Y-coordinates that are less than or equal to second upper-end coordinates (Yiu2) and greater than or equal to second lower-end coordinates (Yib2).

The set of pixels required for lens distortion correction for the third output line (OL3) may be denoted by a third reference line (RL3) that is a portion of the distorted image data (DI). The third reference line (RL3) may refer to a set of pixels corresponding to the reference pixel coordinates matched to coordinates of each of the pixels belonging to the third output line (OL3). The pixels included in the third reference line (RL3) may have Y-axis coordinates that are less than or equal to third upper-end coordinates (Yiu3) and greater than or equal to third lower-end coordinates (Yib3).

Referring to FIG. 4, the range (Yiu2˜Yib2) of the second reference line (RL2) may be smaller in size than the range (Yiu1˜Yib1) of the first reference line (RL1) or the range (Yiu3˜Yib3) of the third reference line (RL3). As the position of lens distortion is located closer to the center of distorted image data (DI), the lens distortion becomes weaker. As the position of lens distortion is located farther from the center of distorted image data (DI), the lens distortion becomes stronger.

Referring back to FIG. 1, the ODC 600 may determine whether to initiate lens distortion correction based on the input pixel coordinates received from the write controller 400. In the examples disclosed herein, a line corresponding to a target line reflecting lens distortion correction to be performed by the ODC 600 will hereinafter be referred to as an output line.

The ODC 600 may pre-store threshold lower-end coordinates corresponding to lower-end coordinates of a reference line required to perform lens distortion correction for the output line. The threshold lower-end coordinates may be experimentally determined according to distortion characteristics of the lens module 110. The ODC 600 may compare the threshold lower-end coordinates of the output line with Y-coordinates of the input pixel coordinates received from the write controller 400, and may determine whether to initiate lens distortion correction for the output line according to the result of comparison. If Y-coordinates of the input pixel coordinates are greater than the threshold lower-end coordinates, the ODC 600 may initiate lens distortion correction for the output line. If the Y-coordinate of the input pixel coordinates is less than or equal to the threshold lower-end coordinates, the ODC 600 may not initiate lens distortion correction for the output line, but may continue monitoring the value of the Y coordinate and wait until the Y-coordinate of the input pixel coordinates becomes greater than the threshold lower-end coordinate.

For example, the ODC 600 may store the first lower-end coordinate (Yib1) of the first reference line (RL1) required for lens distortion correction for the first output line (OL1) as a threshold lower-end coordinate of the first output line (OL1). The image sensing unit 100 may sequentially transmit image data corresponding to the N-th row from the image data corresponding to the first row of the pixel array 120 to the line buffer 300 based on the control of the timing controller 200. As transmission of the image data is underway, the Y-coordinate of the input pixel coordinates may increase sequentially from 1 to N. Assuming that the threshold lower-end coordinates of the first output line (OL1) are set to 30, lens distortion correction for the first output line (OL1) may require image data corresponding to the first to third rows. The ODC 600 may wait until the Y-coordinate of the input pixel coordinates exceeds the coordinate value of 30 without initiating lens distortion correction for the first output line (OL1). When the Y-coordinate of the input pixel coordinates exceeds the coordinate value of 30, the ODC 600 may initiate lens distortion correction for the first output line (OL1).

When lens distortion correction for the output line is started, the ODC 600 may generate output pixel coordinates, which are coordinates of each pixel included in the corresponding output line that reflect the distortion correction performed by the ODC 600. Such generated output pixel coordinates are sent or transmitted to the distortion correction value storage 700 and are stored in the distortion correction value storage 700. In some implementations, the ODC 600 may sequentially perform lens distortion correction for some pixels ranging from one pixel corresponding to the first column to the other pixel corresponding to the M-th column within a specific output line. For example, when lens distortion correction for the first output line (OL1) is started, the ODC 600 may transmit, to the distortion correction value storage 700, the coordinates (1, 1) of a pixel corresponding to the first column within the first output line (OL1) as the output pixel coordinates. Thereafter, when lens distortion correction for the output pixel coordinates (1, 1) is completed, the ODC 600 may transmit, to the distortion correction value storage 700, the coordinates (2, 1) of a pixel corresponding to the second column within the first output line (OL1) as the output pixel coordinates. The above-described operations may be repeatedly performed until lens distortion correction for a pixel corresponding to the M-th column is completed, so that lens distortion correction for the first output line (OL1) can be completed.

The ODC 600 may receive, from the line buffer 300, image data corresponding to the reference pixel coordinates corresponding to the output pixel coordinates transmitted to the distortion correction value storage 700. The ODC 600 may receive a correction parameter from the distortion correction value storage 700 in response to the output pixel coordinates transmitted to the distortion correction value storage 700. The ODC 600 may perform arithmetic processing of the image data received from the line buffer 300 using the correction parameter received from the distortion correction value storage 700, may generate corrected image data, and may transmit the corrected image data to the ISP 900. In some implementations, the arithmetic processing may be an operation for multiplying the image data by a correction parameter, but is not limited thereto.

The distortion correction value storage 700 may select reference pixel coordinates corresponding to the output pixel coordinates received from the ODC 600, and may transmit the selected reference pixel coordinates to the read controller 500. To this end, the distortion correction value storage 700 may store a first table in which the output pixel coordinates and the reference pixel coordinates are mapped to each other.

In addition, the distortion correction value storage 700 may select one or more correction parameters corresponding to the output pixel coordinates received from the ODC 600, and may transmit the selected correction parameter to the ODC 600. To this end, the distortion correction value storage 700 may store a second table in which the output pixel coordinates and the correction parameters are mapped to each other.

The first table and the second table may be experimentally determined based on lens distortion of the lens module 110.

In addition, the distortion correction value storage 700 may transmit the output pixel coordinates received from the ODC 600 to the read speed controller 800.

The read speed controller 800 is a circuit that may select one or more line spacing control values corresponding to the output pixel coordinates received from the distortion correction value storage 700, and may transmit the selected line spacing control value to the read controller 500. To this end, the read speed controller 800 may store a third table in which the output pixel coordinates and the line spacing control values are mapped to each other.

The third table may be experimentally determined based on the lens distortion of the lens module 110 and the capacity of the line buffer 300.

As described above, the read speed controller 800 may control the read speed of the line buffer 300 by adjusting the line spacing control value. In some implementations, the write speed at which the image data is input to the line buffer 300 may be constant, and the read speed at which the image data is output from the line buffer 300 may vary depending on the line spacing control value.

The ISP 900 may perform image processing of the corrected image data received from the ODC 600. The image signal processor 900 may reduce noise of image data, and may perform various kinds of image signal processing (e.g., gamma correction, color filter array interpolation, color matrix, color correction, color enhancement, etc.) for image-quality improvement of the image data. In addition, the ISP 900 may compress image data (IDATA) that has been created by execution of image signal processing for image-quality improvement, such that the ISP 900 can create an image file using the compressed image data. Alternatively, the ISP 900 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created. For example, the image files may be created according to Exchangeable image file format (Exif) standards.

The ISP 900 may transmit the image data obtained by such image signal processing (hereinafter referred to as ISP image data) to the I/O interface 1000.

The I/O interface 1000 may perform communication with the host device 20, and may transmit the ISP image data to the host device 20. In some implementations, the I/O interface 1000 may be implemented as a mobile industry processor interface (MIPI), but is not limited thereto.

The host device 20 may be a processor (e.g., an application processor) for processing the ISP image data received from the imaging device 10, a memory (e.g., a non-volatile memory) for storing the ISP image data, or a display device (e.g., a liquid crystal display (LCD)) for visually displaying the ISP image data.

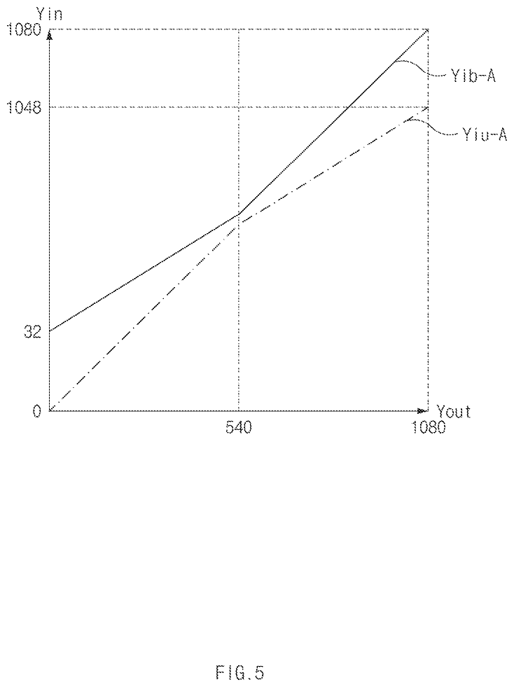

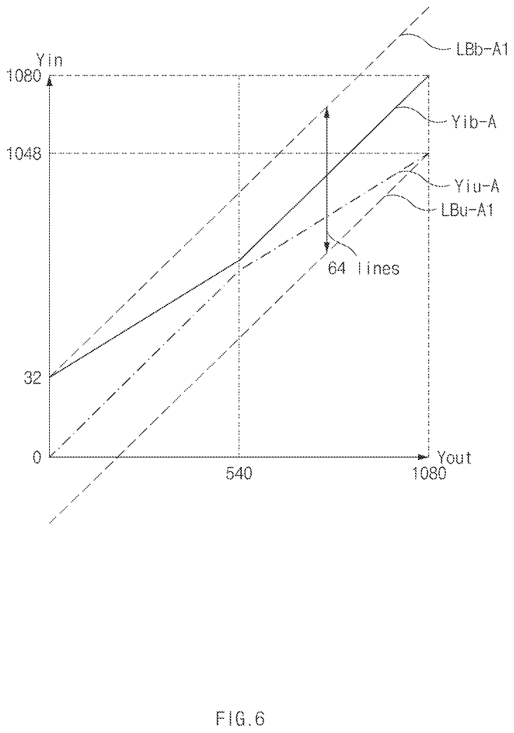

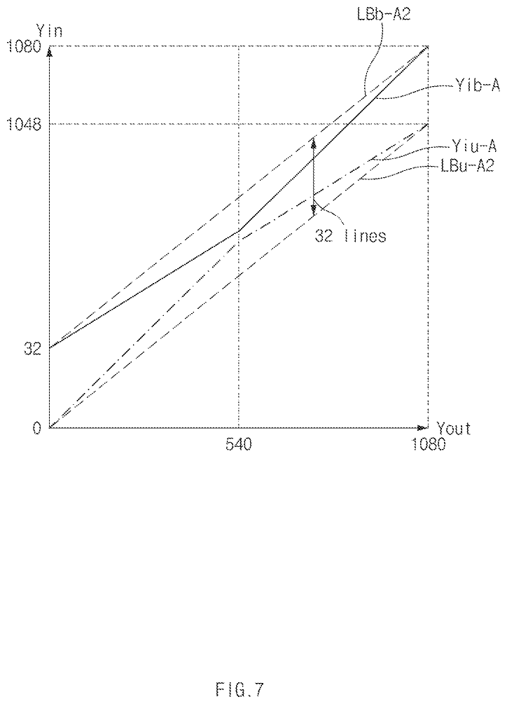

FIG. 5 is a graph illustrating the relationship between output pixel coordinates and input pixel coordinates required for lens distortion correction of pixels corresponding to the output pixel coordinates according to one example of lens distortion. FIG. 6 is a graph illustrating the capacity of a line buffer required when image data is read at a relatively low read speed in the graph of FIG. 5. FIG. 7 is a graph illustrating the capacity of a line buffer required when image data is read at a relatively high read speed in the graph of FIG. 5.

Referring to FIG. 5, the X-axis of the graph may represent the Y coordinate (Yout) of the output pixel coordinates, and the Y-axis of the graph may represent the Y-coordinate (Yin) of the input pixel coordinates. In the following description, it is assumed that the pixel array 120 includes 1080 rows and 1920 columns. Accordingly, each of the Y-coordinate (Yin) of the input pixel coordinates and the Y-coordinate (Yout) of the output pixel coordinates may have a range of 0 to 1080.

As can be seen from FIG. 5 showing one example of lens distortion, FIG. 5 illustrates a graph of how the Y-coordinate (Yin) of the input pixel coordinates required for lens distortion correction of pixels each having the Y-coordinate (Yout) of the output pixel coordinates is changed according to change in the Y-coordinate (Yout) of the output pixel coordinates. In this case, the pixels having the Y-coordinates (Yout) of the same output pixel coordinates can be defined as the output line shown in FIG. 4, and the set of pixels corresponding to the input pixel coordinates required for lens distortion correction of the output line can be defined as the reference line shown in FIG. 4. Although FIG. 4 illustrates that the reference line is the set of pixels corresponding to the reference pixel coordinates matched to coordinates of each of the pixels belonging to the output line, image data corresponding to the same input pixel coordinates as the reference pixel coordinates are read and transmitted to the ODC 600 by operations of the read controller 500 and the line buffer 300 and, as such, the terms “reference pixel coordinates” and “input pixel coordinates” in the following description will be used interchangeably for convenience of description.

In FIG. 5, the change in Y-coordinate (Yin) of the input pixel coordinates required for lens distortion correction of the pixels (i.e., pixels belonging to the output line) each having the Y-coordinate (Yout) of the output pixel coordinates may appear as a change in the upper-end coordinates (Yiu-A) and the lower-end coordinates (Yib-A) of the reference line corresponding to the output line. That is, the pixels included in the reference line corresponding to each output line may have Y coordinates corresponding to the range between the upper-end coordinates (Yiu-A) and the lower-end coordinates (Yib-A), and the upper-end coordinates (Yiu-A) and the lower-end coordinates (Yib-A) may vary depending on the Y-coordinates of the output line.

In one example of lens distortion shown in FIG. 5, as the Y-coordinates of the output line gradually increase, a difference between the upper-end coordinates (Yiu-A) and the lower-end coordinates (Yib-A) gradually decreases until reaching the center portion of the pixel array 120, and then gradually increases after passing the center region (e.g., a portion in which the Y-coordinate of the output line is set to 540) of the pixel array 120.

Referring to FIG. 6, when image data is read from the line buffer 300 at a relatively low read speed, the upper-end storage coordinates (LBu-A1) and the lower-end storage coordinates (LBb-A1) of the line buffer 300 are illustrated. The upper-end storage coordinates (LBu-A1) may refer to the smallest Y-coordinates among the Y-coordinates of the pixels stored in the line buffer 300 when distortion of the output line is corrected, and the lower-end storage coordinates (LBb-A1) may refer to the largest Y-coordinates among the Y-coordinates of the pixels stored in the line buffer 300 when distortion of the output line is corrected.

The read speed of the line buffer 300 may correspond to a slope in the X-axis direction with respect to the Y-axis direction of the upper-end storage coordinates (LBu-A1) or the lower-end storage coordinates (LBb-A1). That is, the read speed of the line buffer 300 may correspond to an increase speed of the upper-end storage coordinates (LBu-A1) or the lower-end storage coordinates (LBb-A1) with respect to the Y-coordinate (Yin) of the input pixel coordinates that increases at a constant speed. The relatively low read speed of FIG. 6 may refer to the same speed as the speed of the Y-coordinate (Yin) of the input pixel coordinates. Thus, the speed at which the image data is input from the image sensing unit 100 to the line buffer 300 may be equal to the speed at which image data is read from the line buffer 300 and transmitted to the ODC 600 (or the speed of lens distortion correction of the ODC 600).

The capacity of the line buffer 300 may be determined within a range within which the line buffer 300 can store image data corresponding to the reference line matched to each output line. As shown in FIG. 6, when the read speed of the line buffer 300 is relatively low, a minimum capacity of the line buffer 300 may correspond to a capacity capable of storing image data of 64 rows (or 64 lines).

Referring to FIG. 7, when image data is read from the line buffer 300 at a relatively low read speed as compared to FIG. 6, the upper-end storage coordinates (LBu-A2) and the lower-end storage coordinates (LBb-A2) of the line buffer 300 are illustrated. The upper-end storage coordinates (LBu-A2) may refer to the smallest Y-coordinates among the Y-coordinates of the pixels stored in the line buffer 300 when distortion of the output line is corrected, and the lower-end storage coordinates (LBb-A2) may refer to the largest Y-coordinates among the Y-coordinates of the pixels stored in the line buffer 300 when distortion of the output line is corrected.

The read speed of the line buffer 300 shown in FIG. 7 may be relatively faster than the read speed of the line buffer 300 shown in FIG. 6. Thus, a slope in the X-axis direction with respect to the Y-axis direction of the upper-end storage coordinates (LBu-A2) or the lower-end storage coordinates (LBb-A2) may be greater than a slope in the X-axis direction with respect to the Y-axis direction of the upper-end storage coordinates (LBu-A1) or the lower-end storage coordinates (LBb-A1).

The relatively high read speed of FIG. 7 may refer to a higher speed than the Y-coordinate (Yin) of the input pixel coordinates. That is, the speed (or the speed of lens distortion correction by the ODC 600) at which image data is read from the line buffer may be higher than the speed at which image data is input from the image sensing unit 100 to the line buffer 300.

As shown in FIG. 7, when the read speed of the line buffer 300 is relatively high, a minimum capacity of the line buffer 300 may correspond to a capacity capable of storing image data of 32 rows (or 32 lines).

In one example of lens distortion shown in FIG. 5, the minimum capacity of the line buffer 300 may be significantly reduced by adjusting the read speed of the line buffer 300.

In one example of lens distortion shown in FIG. 5, the minimum capacity of the line buffer 300 may be reduced by increasing the read speed of the line buffer 300, but is not limited thereto. As another example, the minimum capacity of the line buffer 300 may also be reduced by reducing the read speed of the line buffer 300 depending on the shape of such lens distortion.

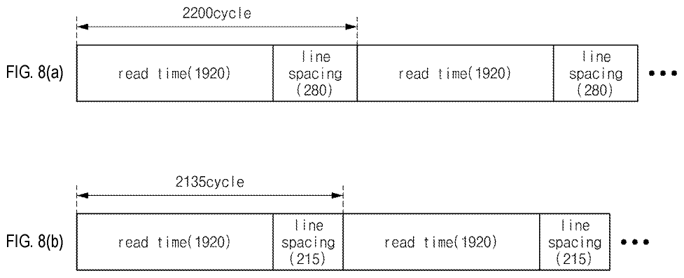

FIGS. 8(a) and 8(b) are diagrams illustrating one example of a method for adjusting the read speed of the line buffer 300.

In more detail, FIG. 8(a) illustrates one example of an output time implemented in a situation where the write speed at which image data is written into the line buffer 300 is equal to the read speed at which image data is read from the line buffer 300 as shown in FIG. 6. Here, the output time may be 2200 cycles corresponding to the sum of a read time of 1920 cycles and the line spacing of 280 cycles. In this case, the read time may refer to a time taken for image data corresponding to one row (or one output line) to be read from the line buffer 300 and to be processed for lens distortion correction by the ODC 600. Since reading and lens distortion correction (hereinafter referred to as the read and lens distortion correction operation) of the image data corresponding to one pixel are performed during one cycle, the read time of 1920 cycles may be used to perform the read and lens distortion correction of image data corresponding to a row (or an output line) including 1920 pixels.

FIG. 8(b) illustrates one example of the output time that enables the read speed at which image data is read from the line buffer 300 to be faster than the write speed at which image data is written into the line buffer 300 as shown in FIG. 7.

In order for the line buffer 300 to have the upper-end storage coordinates (LBu-A2) and the lower-end storage coordinates (LBb-A2) as shown in the graph of FIG. 7, the read and lens distortion correction for the image data corresponding to 1080 rows should be completed while image data corresponding to (1080-32) rows is input to the line buffer 300.

In this case, the output time can be calculated to be “2200 (cycle)×(1080−32)/1080≈2135(cycle)”. That is, after the output time is adjusted to be 2135 cycles, when image data corresponding to (1080−32) rows is input to the line buffer 300, the read and lens distortion correction for the image data corresponding to 1080 rows may be completed.

Here, it is impossible to reduce the read time of 1920 cycles in which the read and lens distortion correction operation of the image data corresponding to a row (or an output line) including 1920 pixels is performed, the line spacing may be reduced from 280 cycles to 215 cycles as shown in FIG. 8(b).

That is, the read speed can increase by reducing the line spacing of the output time.

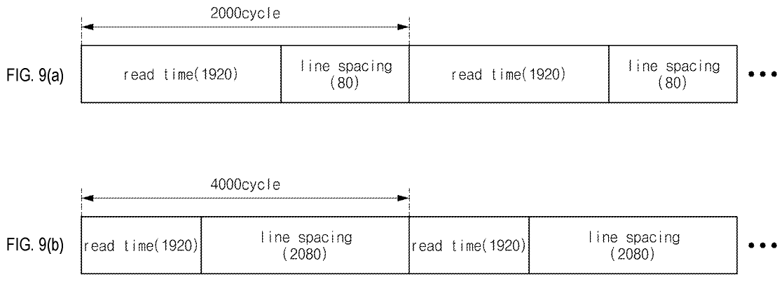

FIGS. 9(a) and 9(b) show diagrams illustrating another example of a method for adjusting the read speed of the line buffer 300.

FIG. 9(a) illustrates another example of an output time implemented in a situation where the write speed at which image data is written into the line buffer 300 is equal to the read speed at which image data is read from the line buffer 300 as shown in FIG. 6. The output time may be 2000 cycles corresponding to the sum of the read time of 1920 cycles and the line spacing of 80 cycles. Thus, the line spacing shown in FIG. 8(b) may be relatively smaller than the line spacing shown in FIG. 8(a).

FIG. 9(b) illustrates another example of the output time that enables the read speed at which image data is read from the line buffer 300 to be faster than the write speed at which image data is written into the line buffer 300 as shown in FIG. 7.

Whereas the embodiment of FIGS. 8(a) and 8(b) can increase the read speed by reducing the line spacing, the output time of FIG. 9(a) has a relatively smaller line spacing so that the embodiment of FIG. 8 has difficulty in reducing the output time.

The embodiment of FIGS. 9(a) and 9(b) allow to increase the read speed by reducing a line spacing. The line spacing can be reduced by increasing a clock frequency of the output side. In this case, the output frequency of the output side may refer to a frequency of the clock signal that is used to read image data from the line buffer 300 and to perform lens distortion correction for the read image data. The clock frequency of the input side may refer to a frequency of the clock signal that is used to generate image data by the image sensing unit 100 and to write the generated image data into the line buffer 300.

The read speed controller 800 in which the line spacing control value is stored may control the clock frequency of the output side. For example, the read speed controller 800 may control a clock signal generator (not shown) for supplying the clock signal to each of the read controller 500, the ODC 600, and the distortion correction value storage 700, thereby changing the clock frequency.

In FIG. 9(b), when the clock frequency of the output side is doubled (e.g., from 80 MHz to 160 MHz), a time corresponding to 1 cycle shown in FIG. 9(b) may be reduced to half of the time corresponding to 1 cycle of FIG. 9(a). Thus, the read time shown in FIG. 9(b) can be reduced to a half of the read time shown in FIG. 9(a).

Therefore, the line spacing can be reduced as much as the amount corresponding to 2080 cycles. By reducing the line spacing, the read speed controller 800 can increase the read speed.

The embodiment of FIGS. 8(a) and 8(b) and the embodiment of FIGS. 9(a) and 9(b) may be combined with each other without being mutually exclusive. For example, the read speed controller 800 can increase the read speed by reducing the line spacing according to the embodiment of FIGS. 8(a) and 8(b), and also can control such line spacing by increasing the clock frequency of the output side and then reducing the line spacing according to the embodiment of FIGS. 9(a) and 9(b). The combined configuration in accordance with the embodiments FIGS. 8(a), 8(b), 9(a) and 9(b) may be utilized to address the limitation existing in controlling the read speed using the line spacing only. By increasing the clock frequency of the output side and then reducing the line spacing, the combined configuration in accordance with the embodiments FIGS. 8(a), 8(b), 9(a) and 9(b) can provide an even higher read speed.

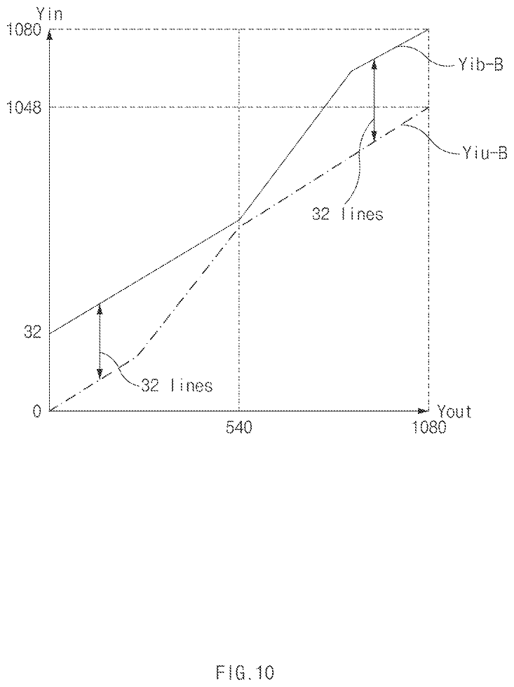

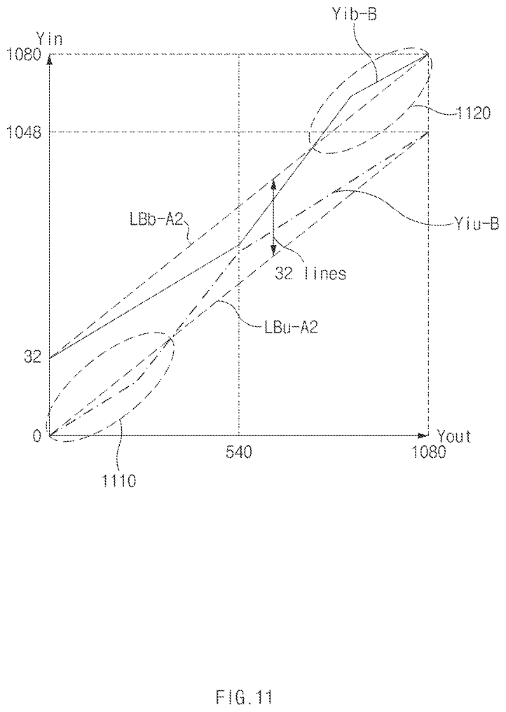

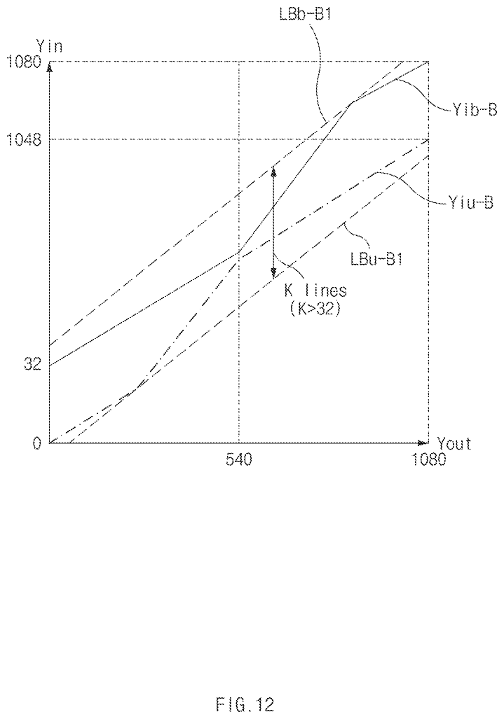

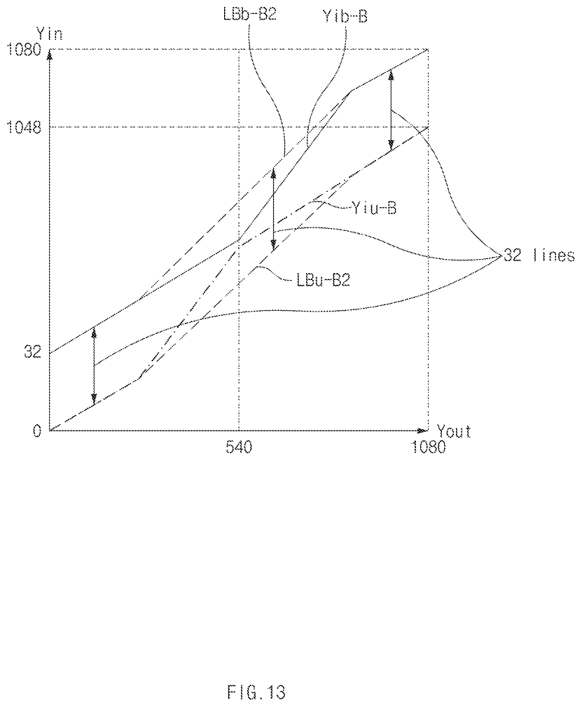

FIG. 10 is a graph illustrating the relationship between output pixel coordinates and input pixel coordinates required for lens distortion correction of pixels corresponding to the output pixel coordinates according to another example of lens distortion. FIG. 11 is a graph illustrating the relationship between the line buffer having the same capacity and the same read speed as those of FIG. 7 and lens distortion of FIG. 10. FIG. 12 is a graph illustrating the capacity of the line buffer required when image data is read at a constant read speed in the graph of FIG. 10. FIG. 13 is a graph illustrating the capacity of the line buffer required when image data is read at a variable read speed in the graph of FIG. 10.

As can be seen from FIG. 10 showing one example of lens distortion, FIG. 10 illustrates a graph of how the Y-coordinate (Yin) of the input pixel coordinates required for lens distortion correction of pixels each having the Y-coordinate (Yout) of the output pixel coordinates is changed according to change in the Y-coordinate (Yout) of the output pixel coordinates.

In one example of lens distortion of FIG. 10 in a different way from FIG. 5, as the Y-coordinates of the output line gradually increase, a difference between the upper-end coordinates (Yiu-B) and the lower-end coordinates (Yib-B) is maintained constant and then gradually decreases until reaching the center portion of the pixel array 120. Thereafter, the difference between the upper-end coordinates (Yiu-B) and the lower-end coordinates (Yib-B) gradually increases after passing the center region of the pixel array 120, and is then maintained constant. In a section in which the difference between the upper-end coordinates (Yiu-B) and the lower-end coordinates (Yib-B) is maintained constant, it is assumed that the difference between the upper-end coordinates (Yiu-B) and the lower-end coordinates (Yib-B) is set to 32. In addition, as can be seen from the graph of FIG. 10, a maximum value between the upper-end coordinates (Yiu-B) and the lower-end coordinates (Yib-B) may be set to 32.

Referring to FIG. 11, the upper-end storage coordinates (LBu-A2) and the lower-end storage coordinates (LBb-A2) of the line buffer 300 having the same capacity and the same read speed as in FIG. 7 are illustrated, and the upper-end storage coordinates (Yiu-B) and the lower-end coordinates (Yib-B) according to another example of lens distortion of FIG. 10 are also illustrated.

Due to presence of the section in which the difference between the upper-end coordinates (Yiu-B) and the lower-end coordinates (Yib-B) is maintained constant, the upper-end coordinates (Yiu-B) within the first section 1110 may deviate from the range between the upper-end storage coordinates (LBu-A2) and the lower-end storage coordinates (LBb-A2) of the line buffer 300, or the lower-end coordinates (Yib-B) within the second section 1120 may deviate from the range between the upper-end storage coordinates (LBu-A2) and the lower-end storage coordinates (LBb-A2) of the line buffer 300.

In the first section 1110 or in the second section 1120, the line buffer 300 may not store the image data of the reference line required for lens distortion correction of the corresponding output line.

Referring to FIG. 12, the upper-end storage coordinates (LBu-B1) and the lower-end storage coordinates (LBb-B1) of the line buffer 300 that can store image data of the reference line required for lens distortion correction of the output line while having the same read speed as in FIG. 7 are illustrated, and the upper-end coordinates (Yiu-B) and the lower-end coordinates (Yib-B) according to another example of lens distortion shown in FIG. 10 are also illustrated.

In order for the line buffer 300 to store image data of the reference line required for lens distortion correction of the output line within all sections of the Y-coordinates (Yout) of the output pixel coordinates, the minimum capacity of the line buffer 300 may be set to a capacity capable of storing image data of K rows (or K lines) (where K is an integer of 32 or greater).

Depending on the type of lens distortion, in order for the line buffer 300 to store image data of the reference line required for lens distortion correction of the output line within all sections of the Y-coordinates (Yout) of the output pixel coordinates, the line buffer 300 may have a capacity greater than a maximum difference between the upper-end coordinates (Yiu-B) and the lower-end coordinates (Yib-B) of lens distortion.

Referring to FIG. 13, the upper-end storage coordinates (LBu-B2) and the lower-end storage coordinates (LBb-B2) of the line buffer 300 which has the same capacity as the maximum value between the upper-end coordinates (Yiu-B) and the lower-end coordinates (Yib-B) of lens distortion and has a variable read speed in a different way from FIG. 7, are illustrated, and the upper-end coordinates (Yiu-B) and the lower-end coordinates (Yib-B) according to another example of lens distortion shown in FIG. 10 are also illustrated.

In FIG. 13, the read speed of the line buffer 300 may be sequentially changed in the order of a first speed→a second speed→the first speed, as the Y-coordinates of the output line gradually increase. Here, the first speed may be higher than the second speed. The slope between the upper-end storage coordinates (LBu-B2) and the lower-end storage coordinates (LBb-B2) of the line buffer 300 is maintained equal to the slope between the upper-end coordinates (Yiu-B) and the lower-end coordinates (Yib-B) of lens distortion (i.e., within a section in which the read speed is set to the first speed), is changed to be smaller than the slope between the upper-end coordinates (Yiu-B) and the lower-end coordinates (Yib-B) of lens distortion (i.e., within a section in which the read speed is set to the second speed), and is then changed to be equal to the slope between the upper-end coordinates (Yiu-B) and the lower-end coordinates (Yib-B) of lens distortion (i.e., within a section in which the read speed is set to the first speed).

In a situation where the read speed of the line buffer 300 is changeable as shown in FIG. 13, even when the line buffer 300 has the same capacity as the maximum difference value (i.e., 32) between the upper-end coordinates (Yiu-B) and the lower-end coordinates (Yib-B) of lens distortion, the line buffer 300 can store image data of the reference line required for lens distortion correction of the output line within all sections of the Y-coordinates (Yout) of the output pixel coordinates. That is, the capacity of the line buffer 300 can be minimized by varying the read speed of the line buffer 300.

As shown in FIGS. 5 to 13, the read speed of the line buffer 300 may be constant or variable, but the read speed controller 800 may determine the read speed in a manner that image data of the reference line required for lens distortion correction of the output line within all sections of the Y-coordinates (Yout) of at least the output pixel coordinates can be maintained in the line buffer 300.

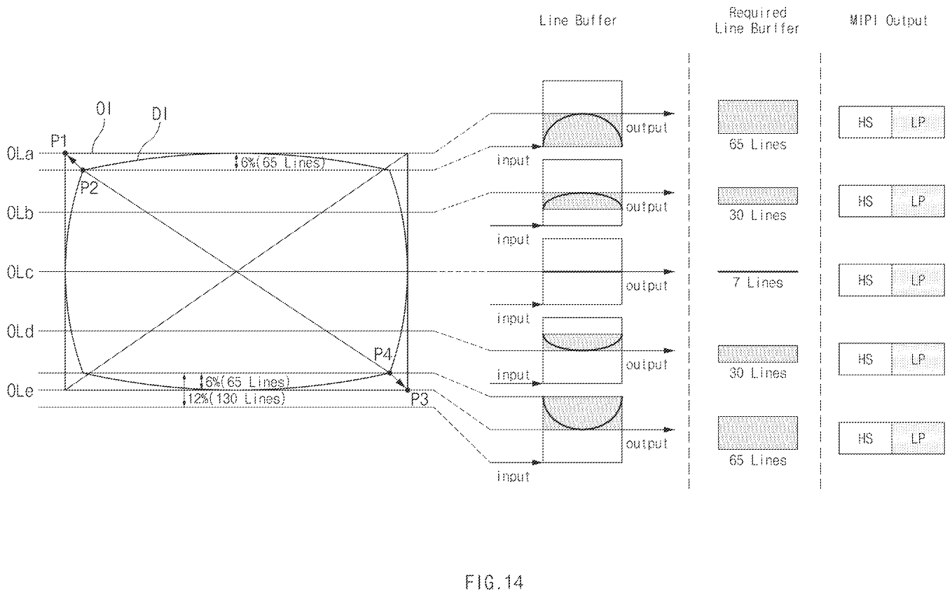

FIG. 14 is a diagram illustrating the capacity of the line buffer required when distorted image data shown in FIG. 3 is read at a constant read speed and lens distortion correction for the distorted image data is performed.

Referring to FIG. 14, original image data (OI) and distorted image data (DI) depicted in FIG. 3 are illustrated. In association with each of 5 output lines (OLa˜OLe), image data stored in the line buffer 300, the capacity of the line buffer 300 required for lens distortion correction, and the operation of the I/O interface 1000 are illustrated in FIG. 14. In this case, the output line (OLa) and the output line (OLe) may correspond to the first output line (OL1) and the third output line (OL3), respectively.

First, the reference lines corresponding to the output line (OLa) and the output line (OLe) may be distributed over 65 rows (corresponding to about 6% of 1080 rows). Therefore, the capacity of the line buffer 300 required for lens distortion correction of the output line (OLa) and the output line (OLe) may correspond to the capacity capable of storing image data of 65 rows (or 65 lines).

The reference lines corresponding to the output line (OLb) and the output line (OLd) may be distributed over 30 rows (corresponding to about 2.8% of 1080 rows). Therefore, the capacity of the line buffer 300 required for lens distortion correction of the output line (OLb) and the output line (OLd) may correspond to the capacity capable of storing image data of 30 rows (or 30 lines).

The reference line corresponding to the output line (OLc) may be distributed over 7 rows (corresponding to about 0.6% of 1080 rows). Therefore, the capacity of the line buffer 300 required for lens distortion correction of the output line (OLc) may correspond to the capacity capable of storing image data of 7 rows (or 7 lines).

Thus, the capacity of the line buffer 300 required for lens distortion correction gradually decreases as the line buffer 300 is disposed closer to the center of the pixel array 120, and gradually increases as the line buffer 300 is disposed farther from the center of the pixel array 120.

In FIG. 14, image data written into the line buffer 300 is displayed as input image data (input), and image data read from the line buffer 300 is displayed as output image data (output). It is assumed that the read speed at which data is read from the line buffer 300 is equal to the write speed at which data is written into the line buffer 300 and is constant. In addition, the speed at which the ODC 600 performs lens distortion correction may also be constant, so that the length of the output section of the I/O interface 1000 can also be kept constant. FIG. 14 illustrates an example of the output section for the case where the I/O interface 1000 is a mobile industry processor interface (MIPI). In FIG. 14, a high speed mode (HS) of the mobile industry processor interface (MIPI) represents a time section in which the ISP image data corresponding to one row is output, and may correspond to the read time shown in FIG. 8. In FIG. 14, a low power mode (LP) of the mobile industry processor interface (MIPI) represents a time section from one HS for any one row to another HS for the next row, and may correspond to the line spacing shown in FIG. 8. That is, in the embodiment of FIG. 14, the speed at which image data is read from the line buffer 300 and lens distortion correction for the read image data is performed is constant, so that the lower power mode (L) corresponding to the line spacing can be maintained constant.

As shown in FIG. 14, if the speed at which data is read from the line buffer 300 and lens distortion correction for the read image data is performed is constant, the line buffer 300 should have the capacity (e.g., 130 lines, about 12% of 1080 rows) corresponding to two times the maximum capacity value (e.g., 65 lines) of the line buffer 300 required for lens distortion correction.

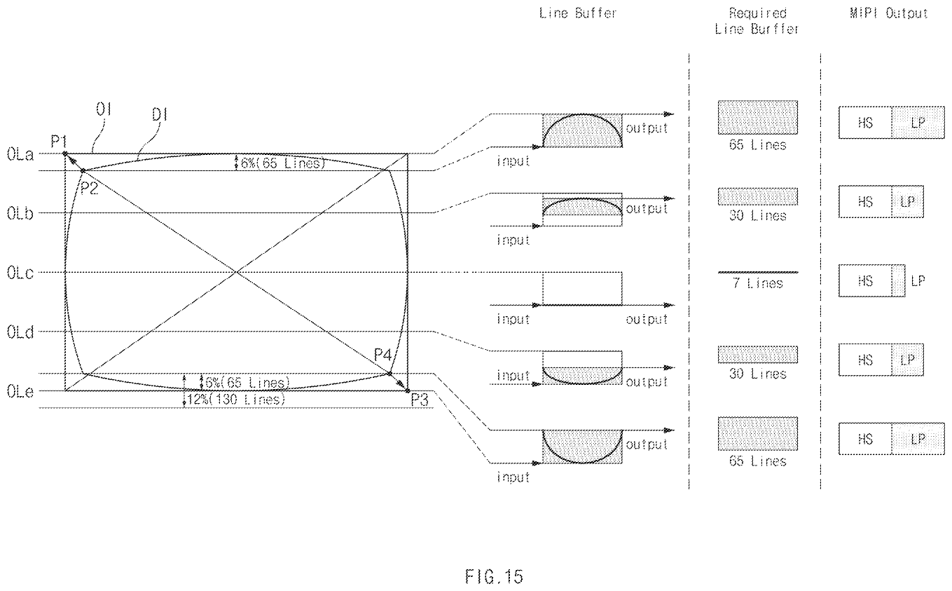

FIG. 15 is a diagram illustrating the capacity of the line buffer required when distorted image data shown in FIG. 3 is read at a variable read speed and lens distortion correction for the distorted image data is performed.

Referring to FIG. 15, original image data (OI) and distorted image data (DI) depicted in FIG. 3 are illustrated. In association with each of 5 output lines (OLa˜OLe), image data stored in the line buffer 300, the capacity of the line buffer 300 required for lens distortion correction, and the operation of the I/O interface 1000 are illustrated in FIG. 15.

In FIG. 15, the speed at which image data is read from the line buffer 300 and lens distortion correction for the read image data is performed as shown in FIG. 15 may be variable rather than constant differently from FIG. 14.

In some implemenations, the speed at which image data is read from the line buffer 300 and the speed at which the ODC 600 performs lens distortion correction may be changed according to the capacity (i.e., the number of one or more reference lines corresponding to the output line) of the line buffer 300 required for lens distortion correction. The speed at which image data is read from the line buffer 300 and the speed at which the ODC 600 performs lens distortion correction may increase as the capacity of the line buffer 300 required for lens distortion correction decreases (or as the number of one or more reference lines corresponding to the output line is reduced). Thereafter, as the capacity of the line buffer 300 required for lens distortion correction increases (or as the number of one or more reference lines corresponding to the output line increases), the speed at which image data is read from the line buffer 300 and the speed at which the ODC 600 performs lens distortion correction may decrease.

The speed at which image data is read from the line buffer 300 and the speed at which the ODC 600 performs lens distortion correction can be controlled by adjusting the length of the line spacing as described in FIG. 8. Since the speed at which image data is read from the line buffer 300 and lens distortion correction of the read image data is performed can be changed as shown in FIG. 15, the length (i.e., LP length) of a low power mode (LP) decreases as the capacity of the line buffer 300 required for lens distortion correction decreases, and then increases as the capacity of the line buffer 300 required for lens distortion correction increases.

For example, it is assumed that the number of one or more reference lines required for lens distortion correction for the output line corresponding to Y-coordinates (Yout) of 300˜310 is set to 20 (i.e., 20 lines), the number of one or more reference lines required for lens distortion correction for the output line corresponding to Y-coordinates (Yout) of 311˜326 is set to 19 (i.e., 19 lines), and the number of one or more reference lines required for lens distortion correction for the output line corresponding to Y-coordinates (Yout) of 327˜344 is set to 18 (i.e., 18 lines). In addition, it is assumed that the output time for the output line corresponding to Y-coordinates (Yout) of 300˜310 is denoted by 2200 cycles.

While lens distortion correction for the output line corresponding to 16 Y-coordinates (Yout) of 311˜326 is performed, in order to increase the read speed in response to capacity reduction indicating that the capacity of the line buffer 300 required for lens distortion correction is reduced by one line, the output time for lens distortion correction for one output line may be reduced by about 138 cycles (2200/16=137.5), resulting in formation of the resultant output time denoted by 2062 cycles (2200−138=2062 cycles).

While lens distortion correction for the output line corresponding to 18 Y-coordinates (Yout) of 327˜344 is performed, in order to increase the read speed in response to capacity reduction indicating that the capacity of the line buffer 300 required for lens distortion correction is reduced by one line, the output time for lens distortion correction for one output line may be reduced by about 123 cycles (2200/18=122.2), resulting in formation of the resultant output time denoted by 2077 cycles (2200−123=2077 cycles).

As illustrated in FIG. 15, the use efficiency of the line buffer 300 can be maximized when the speed at which image data is read from the line buffer 300 and the lens distortion correction is performed are changed in response to the capacity of the line buffer 300 required for lens distortion correction.

In this case, as illustrated in FIG. 7 or FIG. 13, the line buffer 300 has the same capacity as the maximum capacity (e.g., 65 lines) of the line buffer 300 required for lens distortion correction, so that the read speed of the line buffer 300 can be appropriately determined in consideration of the shape of lens distortion, the capacity of the line buffer 300, performance of the ODC 600, or others.

As is apparent from the above description, the imaging device based on some implementations of the disclosed technology can minimize the capacity required for the line buffer by varying the read speed of the line buffer.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. An imaging device comprising:
an image sensing unit structured to include image sensing pixels operable to sense incident light received from a scene and to generate image data carrying image information of the scene;
a lens module positioned to project the incident light from the scene onto the image sensing pixels of the image sensing unit;
a line buffer coupled to be in communication with the image sensing unit and configured to store the image data received from the image sensing unit;
an optical distortion corrector (ODC) configured to perform lens distortion correction for output pixel coordinates based on input pixel coordinates of the image data stored in the line buffer to correct a distortion caused by the lens module; and
a line buffer controller including a read controller and coupled to the line buffer and configured to control a read speed at which the image data is read from the line buffer to the optical distortion corrector according to the output pixel coordinates.

2. The imaging device according to claim 1, further comprising:
a distortion correction value storage configured to select reference pixel coordinates corresponding to the output pixel coordinates; and
wherein the line buffer controller is configured to control the line buffer to read image data corresponding to the reference pixel coordinates.

3. The imaging device according to claim 2, wherein:
the distortion correction value storage is configured to transmit a correction parameter corresponding to the output pixel coordinates to the optical distortion corrector (ODC).

4. The imaging device according to claim 3, wherein:
the optical distortion corrector (ODC) is configured to receive the image data corresponding to the reference pixel coordinates corresponding to the output pixel coordinates from the line buffer, calculate the image data corresponding to the reference pixel coordinates and the correction parameter corresponding to the output pixel coordinates, and thus perform the lens distortion correction based on the result of calculation.

5. The imaging device according to claim 2, wherein:
the line buffer controller is configured to control the read speed using a line spacing between read times of adjacent rows of a pixel array included in the image sensing unit.

6. The imaging device according to claim 5, wherein:
the line buffer controller is configured to increase the read speed by reducing the line spacing, or is configured to reduce the read speed by increasing the line spacing.

7. The imaging device according to claim 5, wherein:
the line buffer controller is configured to determine the read speed so that image data corresponding to a reference line corresponding to an output line including the output pixel coordinates is maintained in the line buffer.

8. The imaging device according to claim 5, wherein:
the line buffer controller is operable to reduce the line spacing as the number of one or more reference lines corresponding to an output line including the output pixel coordinates decreases.

9. The imaging device according to claim 5, wherein:
the line buffer controller is operable to increase the line spacing as the number of one or more reference lines corresponding to an output line including the output pixel coordinates increases.

10. The imaging device according to claim 5, wherein:
the read speed is higher than a write speed at which the image data is written into the line buffer.

11. The imaging device according to claim 5, wherein:
the line buffer controller is configured to control the read speed using the line spacing after an increase of a clock frequency of each of the read controller and the optical distortion corrector (ODC).

12. The imaging device according to claim 2, further comprising:
a write controller configured to transmit the input pixel coordinates to each of the line buffer and the optical distortion corrector (ODC).

13. The imaging device according to claim 12, wherein:
the line buffer is configured to store the input pixel coordinates mapped to the image data; and
the line buffer is configured to read image data corresponding to input pixel coordinates as same as the reference pixel coordinates received from the read controller.

14. The imaging device according to claim 12, wherein:
the optical distortion corrector (ODC) is configured to compare lower-end coordinates of a reference line corresponding to an output line including the output pixel coordinates with the input pixel coordinates, and determine whether to start lens distortion correction of the output pixel coordinates based on a result of comparison.

15. An imaging device comprising:
a line buffer configured to store image data generated by sensing incident light;
an optical distortion corrector (ODC) configured to receive the image data from the line buffer and perform lens distortion correction for output pixel coordinates; and
a line buffer controller configured to control a read speed at which the image data is read from the line buffer, based on a reference line corresponding to an output line including the output pixel coordinates.

16. The imaging device of claim 15, wherein the line buffer controller is configured so that the read speed is based on a capacity of the line buffer.

17. The imaging device of claim 15, wherein the line buffer controller is configured to control the read speed using a line spacing between read times of adjacent rows of a pixel array.

18. The imaging device according to claim 15, wherein the line buffer controller is configured to change the read speed by changing the line spacing.

19. The imaging device according to claim 15, wherein the line buffer controller is configured to control the line buffer to read image data corresponding to the reference pixel.

20. The imaging device of claim 19, wherein the line buffer controller is operable to change the read speed after an increase of a clock frequency associated with the line buffer controller.
